(19) United States
(12) Patent Application Publication
(10) Pub. No.: US 2016/0068073 A1
(43) Pub. Date: Mar. 10, 2016

(54) DC Fast Charge Testing Method and System for Electric Vehicles

(71) Applicant: Ford Global Technologies, LLC, Dearborn, MI (US)

(72) Inventors: Kendrick J. Taylor, Canton, MI (US); Mark J. Ferrel, Brighton, MI (US)

(21) Appl. No.: 14/478,473

(22) Filed: Sep. 5, 2014

(51) Int. Cl. B60L 11/18

(52) U.S. Cl. CPC B60L 11/1809

(57) ABSTRACT

A charge test device lacks ability to provide electrical power for charging an electric vehicle. The test device is configured to communicate, with the vehicle, communications which electric vehicle supply equipment (EVSE) having the ability to provide the electrical power for charging the vehicle would communicate with the vehicle to initiate charging of the vehicle. The EVSE may be DC fast charge EVSE having the ability to provide electrical power for DC fast charging the vehicle. The test device may be further configured to indicate responses of the vehicle to the communications communicated with the vehicle such that diagnosis of a failed charge event of the vehicle by the EVSE can be performed using the responses of the vehicle to the communications communicated with the vehicle.

### TECHNICAL FIELD

This disclosure relates to DC fast charging of electric vehicles such as plug-in hybrid electric vehicles and battery-only electric vehicles.

### BACKGROUND

DC fast charge electric vehicle supply equipment (EVSE) includes a charge station having a charge coupler. The charge coupler plugs into a corresponding charge socket of an electric vehicle (EV) to connect the charge station to the EV. The charge station is separately connected to the electrical grid and is configured to convert AC electrical power from the grid to a relatively high DC electrical power (e.g., 200-500V * 80-200 A). A controller of the EVSE and a controller of the EV perform a handshaking operation by communicating with one another through the charge coupler and the charge socket. The charge station provides the relatively high DC electrical power to the EV upon a successful handshaking operation.

The handshaking operation between the EVSE and the EV may not be successful. Consequently, in such cases, the DC fast charging operation is not performed. Diagnosis of the EV controller and associated wiring may identify the cause of a failed DC fast charging event. Technicians perform the diagnosis based on the operation of the EV and/or diagnostic trouble codes (DTCs) generated while the EVSE is attempting to initiate DC fast charge of the EV.

DC fast charge EVSEs are generally in short supply, expensive, and immobile. It may therefore be difficult for technicians to have the opportunity to perform the diagnosis as the diagnosis process entails observing results (e.g., observing EV operation and/or DTCs) caused or generated in response to an actual DC fast charge EVSE initiating DC fast charging of the EV. That is, the diagnosis process entails using an actual DC fast charge EVSE which is generally in short supply, expensive, and immobile as indicated.

### SUMMARY

Embodiments of the present disclosure enable diagnosis of a failed charge event of an electric vehicle (EV) by electrical vehicle supply equipment (EVSE) to be performed without using the EVSE.

Embodiments of the present disclosure provide DC fast charge testing methods and systems which overcome the above-noted difficulties associated with using an actual DC fast charge EVSE to diagnosis the cause of a failed DC fast charge event by enabling the diagnosis to be performed without having to use an actual DC fast charge EVSE.

Operation of the DC fast charge testing methods and systems include simulating the DC fast charge initiation process (e.g., handshaking operation) of an actual DC fast charge EVSE with an EV. The simulation includes using a portable and/or handheld DC fast charge testing device configured to initiate DC fast charging with an EV. The testing device appears to an EV as being an actual DC fast charge EVSE. However, in contrast to an actual DC fast charge EVSE, the testing device lacks the capability of being able to DC fast charge an EV. This is because the testing device is not configured to provide the relatively high DC electrical power which an actual DC fast charge EVSE is able to provide. The testing device lacks the capability to provide the relatively high DC electrical power as the testing device lacks the charge station of an actual DC fast charge EVSE. As such the testing device appears to an EV as being an actual DC fast charge EVSE during the DC fast charge initiation process. That is, the testing device appears to an EV as being an actual DC fast charge EVSE up to the point at which the relatively high DC electrical power is to be provided to the EV to DC fast charge the EV.

An embodiment of the present disclosure provides a system for an EV. The system includes a test device. The test device lacks ability to provide electrical power for charging the EV and is configured to communicate, with the EV, communications which electric vehicle supply equipment EVSE having the ability to provide the electrical power for charging the EV would communicate with the EV to initiate charging of the EV. In this way, the test device appears to the EV as being the EVSE. The EVSE, which the test device appears to the EV as being, may be DC fast charge EVSE having the ability to provide electrical power for DC fast charging the EV.

An embodiment of the present disclosure provides a method for an EV. The method includes communicating, with the EV, by a test device lacking ability to provide electrical power for charging the EV, communications which EVSE having the ability to provide the electrical power for charging the EV would communicate with the EV to initiate charging of the EV. Again, in this way, the test device appears to the EV as being the EVSE and the EVSE may be DC fast charge EVSE having the ability to provide electrical power for DC fast charging the EV. The method may further include: indicating, by the test device, responses of the EV to the communications communicated with the EV; and diagnosing a failed charge event of the EV by the EVSE using the responses of the EV to the communications communicated with the EV.

An embodiment of the present disclosure provides another system for an EV. This system includes a test device lacking ability to provide electrical power for charging the vehicle and configured to appear to the vehicle, up to a point at which the electrical power for charging the vehicle is to be provided to the vehicle, as being an electric vehicle supply equipment (EVSE) having the ability to provide the electrical power for charging the vehicle.

### BRIEF DESCRIPTION OF THE DRAWINGS

FIG. 1 illustrates a charge station environment having a DC fast charge electric vehicle supply equipment (EVSE) connected to an electric vehicle (EV);

FIG. 2 illustrates a block diagram of a DC fast charge testing device for an EV in accordance with an embodiment of the present disclosure; and

FIG. 2A illustrates an enlarged view of the circled area 2A of FIG. 2.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

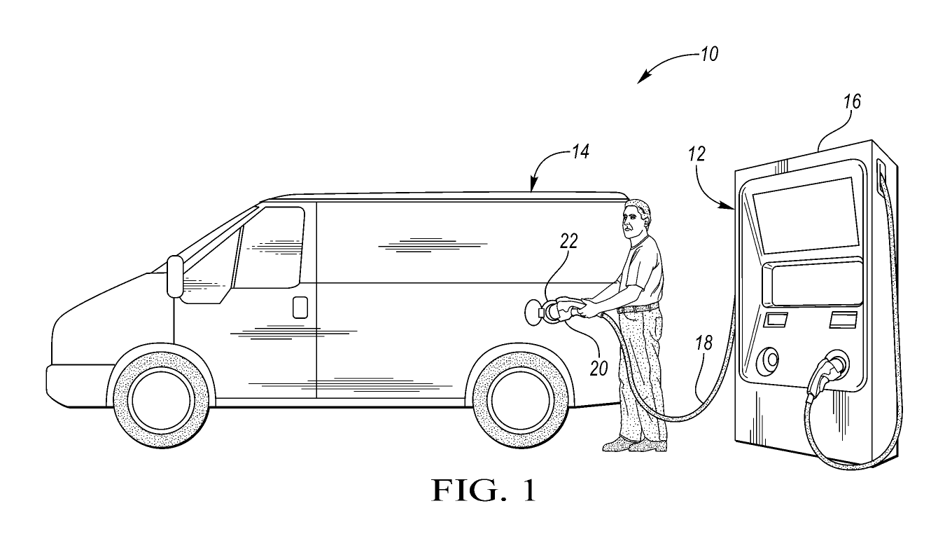

Referring now to FIG. 1, a charge station environment 10 having a DC fast charge electric vehicle supply equipment (EVSE) 12 connected to an electric vehicle (EV) 14 is shown. EVSE 12 includes a charge station 16 having a charge cable 18 with a charge coupler 20. Charge station 16 is connected to the electrical grid and is configured to convert AC electrical power from the grid to a relatively high DC electrical power (e.g., 200-500V * 80-200 A). Charge coupler 20 is connected to charge station 16 via charge cable 18. Charge station 16 and/or charge coupler 20 include a controller (not shown) for controlling the charging operation of EVSE 12.

As an example, charge coupler 20 meets the specifications defined in Society of Automotive Engineering Specification SAE J1772 such as SAE J1772 combo connector specification. Alternatively, charge coupler 20 may be configured differently such as to meet the CHAdeMO plug specification or other specifications.

EV 14 includes a charge socket 22 which corresponds to charge coupler 20. Charge socket 22 is a component of on-board vehicle charging infrastructure of EV 14. The on-board vehicle charging infrastructure is connected to the high-voltage battery system of EV 14 and includes a controller (not shown) for controlling the charging operation of EV 14.

As shown in FIG. 1, charge coupler 20 plugs into charge socket 22 to connect EVSE 12 to EV 14. The controllers of EVSE 12 and EV 14 perform a handshaking operation by communicating with one another over a communications line established through charge coupler 20 and charge socket 22. Charge station 16 provides the relatively high DC electrical power to charge coupler 20 and thereby to charge socket 22 for charging EV 14 upon a successful handshaking operation.

As indicated above, the DC fast charging event may fail due to, for instance, the handshaking operation not being successful. Diagnosis of the controller of EV 14 and associated wiring may identify the reason for the failed DC fast charging event. Such diagnosis has entailed using EVSE 12 (which includes the relatively scarce, expensive, and immobile charge station 16) to initiate DC fast charging of EV 14 (e.g., to initiate the DC fast charge handshaking operation with the EV) and observing the response of the EV. The observed response of EV 14 may include the operation of the EV itself and/or DTCs generated while EVSE 12 is attempting to initiate a DC fast charge of the EV.

As further indicated above, embodiments of the present disclosure provide DC fast charge testing methods and systems which overcome the above-noted difficulties associated with using EVSE 12 to diagnosis the cause of a failed DC fast charging event. The testing methods and systems overcome these difficulties by enabling the diagnosis to be performed without having to use an actual DC fast charge EVSE such as EVSE 12 having a charge station such as charge station 16. Operation of the testing methods and systems include simulating the DC fast charge initiation process (e.g., handshaking operation) of EVSE 12 with EV 14. The simulation includes using a portable and/or handheld DC fast charge testing device configured to initiate DC fast charging with EV 14.

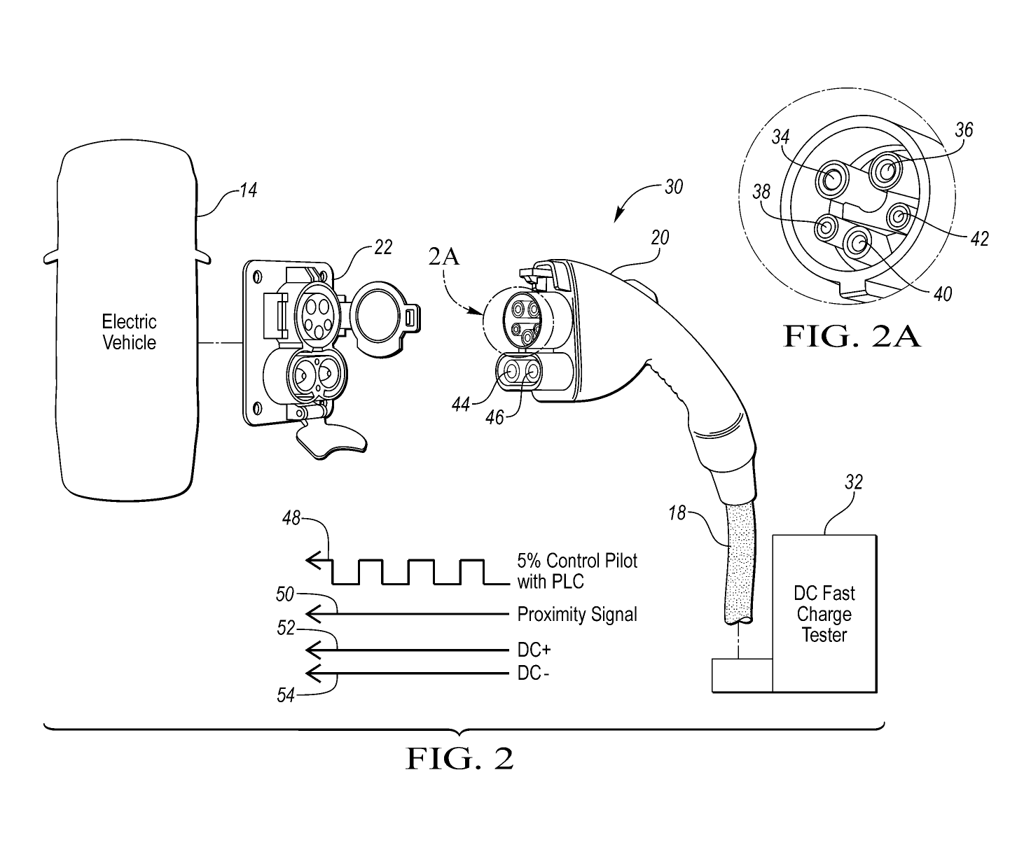

Referring now to FIG. 2, with continual reference to FIG. 1, a block diagram of a DC fast charge testing device 30 in accordance with an embodiment of the present disclosure is shown. Testing device 30 includes a charge coupler 20 and possibly a charge cord 18. Unlike EVSE 12, testing device 30 does not include a DC fast charge station such as charge station 16. Further unlike EVSE 12, testing device 30 includes a DC fast charge tester 32. Tester 32 is connected to charge coupler 20 via charge cord 18. Alternatively, tester 32 is incorporated into charge coupler 20 in which case charge cord 18 is extraneous. In either event, testing device 30 is therefore portable and may be handheld as the testing device lacks a DC fast charge station.

DC fast charge tester 32 includes an electronic processor or the like configured to simulate the DC fast charge initiation process (e.g., handshaking operation) of EVSE 12 with EV 14. Tester 32 can communicate with EV 14 the DC fast charge handshaking signaling signals to initiate a DC fast charge of the EV while charge coupler 20 is plugged into charge socket 22.

DC fast charge testing device 30 appears to EV 14 as being EVSE 12 during the DC fast charge initiation process. That is, testing device 30 appears to EV 14 as being EVSE 12 up to the point at which the relatively high DC electrical power is to be provided to the EV to DC fast charge the EV. This is because DC fast charge tester 32 is configured to simulate the DC fast charge initiation process of EVSE 12. As such, testing device 30 in place of EVSE 12 can be used during the diagnosis process to diagnose the cause of a failed DC fast charging event. As a result, the diagnosis may be performed without using EVSE 12 and its attendant charge station 16.

DC fast charge testing device 30 does not include a DC fast charge charging station as the testing system lacks the capability of actually being able to DC fast charge EV 14. This is because testing device 30 is not configured to provide to EV 14 the relatively high DC electrical power which EVSE 12 is able to provide. Testing device 30 is to generally conduct the DC fast charge initiation process with EV 14. An exception is that DC fast charge tester 32 may be further configured to provide relatively low DC electrical power (e.g., 1-12V * milliamp current) for continuity measurements in place of the relatively high DC electrical power which EVSE 12 can provide.

As indicated above, as an example, charge coupler 20 of DC fast charge testing device 30 and corresponding charge socket 22 meet the SAE J1772 DC fast charge specification. Accordingly, as shown in FIG. 2, charge coupler 20 includes seven conductor pins: first AC pin 34, second AC pin 36, ground pin 38, proximity detection pin 40, control pilot pin 42, first DC pin (DC⁺) 44, and second DC pin (DC⁻) 46. Correspondingly, charge socket 22 includes seven sockets (not labeled): first AC socket, second AC socket, ground socket, proximity detection socket, control pilot socket, first DC socket (DC⁺), and second DC socket (DC⁻).

As described, DC fast charge tester 32 is configured to function with charge coupler 20 to provide the operational requirements set forth in, for example, the DC fast charge SAE J1772 specification with the exception of being configured to provide the relatively high DC electrical power used to DC fast charge EV 14. As such, tester 32 is configured to provide the requisite performance specifications with the exception of being configured to provide the relatively high DC electrical power required for DC fast charging EV 14.

DC fast charge tester 32 includes a central processing unit (CPU) or microprocessor and a memory storing a set of program instructions in the form of firmware. The microprocessor executes the program instructions to perform various functions including implementing the required communication protocols (i.e., power line communication (PLC) information according to the SAE specification) with the on-board vehicle charging infrastructure of EV 14. (In the case of charge coupler 20 being configured to meet the CHAdeMO plug specification the required communication protocols include controller area network (CAN) information instead of PLC information.)

Pursuant to the DC fast charge SAE J1772 specification, the communication protocols including the DC fast charge handshaking operation are implemented by tester 32 and the controller of the on-board vehicle charging infrastructure of EV 14 imposing a sequence of voltage changes on control pilot pin 42. For this purpose, analog circuitry of tester 32 is coupled between the processor of the tester and control pilot pin 42. This feature enables tester 32 to impose DC signal voltages (i.e., a digital communication signal) on control pilot pin 42 and to sense the responsive digital communication signal imposed on the control pilot pin by the controller of the on-board vehicle charging infrastructure of EV 14. The controller of the on-board vehicle charging infrastructure of EV 14 responds appropriately to changes in the digital communication signal on control pilot pin 42 in accordance with the required communication protocols.

As described, DC fast charge tester 32 generates a digital communication signal on control pilot pin 42 in order to initiate the DC fast charge with EV 14. The controller of the on-board vehicle charging infrastructure of EV 14 responds to the DC fast charge initiation with a modified version of the digital communication signal on control pilot pin 42. In this way, tester 32 and the controller of the on-board vehicle charging infrastructure of EV 14 communicate with one another using the digital communication signal on control pilot pin 42. Pursuant to the DC fast charge SAE J1772 specification, the digital communication signal communicated over control pilot pin 42 is a 1 kHz square wave +/−12V digital communication signal 48 as shown in FIG. 2.

The voltage amplitude and the frequency of digital communication signal 48 define the charging state of EV 14. For instance, the charging states can be defined as follows: State A, pilot high +12V, pilot low N/A, and the frequency being DC as opposed to 1 kHz means that EV 14 is not connected to DC fast charge testing device 30; State B, pilot high +9V, pilot low −12V, and the frequency 1 kHz means that the EV is connected to the testing device and is ready to be charged; State C, pilot high +6V, pilot low −12V, and the frequency 1 kHz means that the EV is being charged by the testing device (which is therefore an error as the testing device is incapable of charging the EV); State D, pilot high +3V, pilot low −12V, and the frequency 1 kHz means that the EV requires ventilation prior for the charging to being enabled; State E, pilot high 0V, pilot low 0V, and the frequency being N/A means an error; and State F, pilot high being N/A, pilot low −12V, and the frequency being N/A means an error.

Digital communication signal 48 further has a given pulse duty cycle as shown in FIG. 2. A pulse generator of tester 32 performs pulse modulation of digital communication signal 48 to control the duty cycle of the digital communication signal. The duty cycle signifies to EV 14 a simulated maximum allowable charging current that may be provided to the EV.

As described, DC fast charge tester 32 communicates with the controller of the on-board vehicle charging infrastructure of EV 14 using the digital communication signal on control pilot pin 42 to carry out portions of the signaling protocol for initiating a DC fast charge with the EV. For instance, the signaling protocol includes: tester 32 signaling the presence of the relatively high DC electrical power (which in reality is not available from DC fast charge testing device 30); EV 14 detecting charge coupler 20 via proximity signal 50 provided by the tester; the tester detecting the EV; the tester indicating to the EV readiness to supply the relatively high DC electrical power; the EV determining ventilation requirements; the tester indicating to the EV the current capacity of the relatively high DC electrical power; and the EV commanding electrical power flow.

As noted above, DC fast charge test device 30 may be configured to provide relatively low DC electrical power (e.g., 1-12V * milliamp current) for continuity measurements in place of the relatively high DC electrical power which EVSE 12 can provide. DC fast charge tester 30 generates such relatively low electrical power signals 52 and 54 on first DC pin (DC⁺) 44 and second DC pin (DC⁻) 46 of charge coupler 20.

As described, a DC fast charge testing device in accordance with embodiments of the disclosure simulates the signals that a DC fast charge EVSE would generate to trigger fast charge on the vehicle side. The testing device could include indicators for an open circuit (similar to what is required for Level 1 EVSE), a port for computer connection (USB or similar) to read and/or transmit the PLC (Power Line Communication) information, and/or a breakout box to assist in the diagnosis of a DC fast charge issue. Such indicators could be text displayed on a display screen or a series of light emitting diodes (LEDs) that represent faults called out in a provided decoder manual.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A system for an electrical vehicle, comprising:
a test device lacking ability to provide electrical power for charging the vehicle and configured to communicate, with the vehicle, communications which electric vehicle supply equipment (EVSE) having the ability to provide the electrical power for charging the vehicle would communicate with the vehicle to initiate charging of the vehicle.

2. The system of claim 1 wherein:
the test device is a DC fast charge testing device lacking ability to provide electrical power for DC fast charging the vehicle and is configured to communicate, with the vehicle, communications which DC fast charge EVSE would communicate with the vehicle to initiate charging of the vehicle.

3. The system of claim 1 wherein:
the test device is further configured to indicate responses of the vehicle to communications of the test device communicated with the vehicle.

4. The system of claim 3 wherein:
the test device is further configured to indicate a cause of a failed charge event of the vehicle by the EVSE using the responses of the vehicle to the communications of the test device communicated with the vehicle.

5. The system of claim 1 wherein:
the test device is further configured to appear to the vehicle as being the EVSE during a charge initiation process.

6. The system of claim 1 wherein:
the test device is further configured to appear to the vehicle as being the EVSE up to a point at which the electrical power for charging the vehicle is to be provided.

7. The system of claim 1 wherein:
the test device includes a processor configured to communicate, with the vehicle, the communications which the EVSE would communicate with the vehicle to initiate charging of the vehicle.

8. The system of claim 1 wherein:
the test device further includes a charge coupler configured to be plugged to a corresponding vehicle socket to connect the test device to the vehicle in order for the test device to be able to communicate with the vehicle.

9. The system of claim 8 wherein:
the charge coupler of the test device has a configuration corresponding to a configuration of a charge coupler of the EVSE.

10. The system of claim 8 wherein:
the test device includes a processor configured to communicate, with the vehicle, via the charge coupler, the communications which the EVSE would communicate with the vehicle to initiate charging of the vehicle.

11. The system of claim 1 wherein:
the test device is a handheld device.

12. A method for an electrical vehicle, comprising:
communicating, with the vehicle, by a test device lacking ability to provide electrical power for charging the vehicle, communications which electric vehicle supply equipment (EVSE) having the ability to provide the electrical power for charging the vehicle would communicate with the vehicle to initiate charging of the vehicle.

13. The method of claim 12 wherein:
communicating includes communicating, with the vehicle, by the test device, communications which DC fast charge EVSE would communicate with the vehicle to initiate DC fast charging of the vehicle.

14. The method of claim 12 further comprising:
indicating, by the test device, responses of the vehicle to the communications communicated with the vehicle.

15. The method of claim 14 further comprising:
diagnosing a failed charge event of the vehicle by the EVSE using the responses of the vehicle to the communications communicated with the vehicle.

16. A system for an electrical vehicle, comprising:
a test device lacking ability to provide electrical power for charging the vehicle and configured to appear to the vehicle, up to a point at which the electrical power for charging the vehicle is to be provided to the vehicle, as being an electric vehicle supply equipment (EVSE) having the ability to provide the electrical power for charging the vehicle.

17. The system of claim 16 wherein:
the test device is a DC fast charge testing device lacking ability to provide electrical power for DC fast charging the vehicle and is configured to communicate, with the vehicle, communications which DC fast charge EVSE would communicate with the vehicle to initiate charging of the vehicle.

18. The system of claim 16 wherein:
the test device is a handheld device.
